(19) United States
(12) Patent Application Publication
(10) Pub. No.: US 2011/0038737 A1
(43) Pub. Date: Feb. 17, 2011

(54) MULTI-STAGE COMPRESSOR

(76) Inventors: Ronald David Conry, Tallahassee, FL (US); Henrik Vestergaard Joergensen, Soenderborg (DK); Jose Lopes Alvares, JR., Tallahassee, FL (US)

Correspondence Address: CARLSON, GASKEY & OLDS, P.C., 400 WEST MAPLE ROAD, SUITE 350, BIRMINGHAM, MI, 48009, US

(21) Appl. No.: 12/933,447

(22) PCT Filed: Oct. 8, 2008
(86) PCT No.: PCT/IB2008/003717

§ 371 Date: Sep. 20, 2010

Related U.S. Application Data
(60) Provisional application No. 60/984,466, filed on Nov. 1, 2007.

(51) Int. Cl. F04B 25/00; F03G 7/00

(52) U.S. Cl. 417/53; 417/244; 416/3

(57) ABSTRACT

A system and a method for adding and subtracting stages of compression to a compressor as and when the compressor requires them. If the compressor needs only a low pressure ratio, then the system and method allow the compressor to operate with only a primary pumping circuit spinning, while available additional stages, forming a secondary pumping circuit, and which may be required at other times when the needed pressure ratios increase, are decoupled from the rotating shaft, so that the compressor pumps at its most efficient and flexible point. Further, a system and method for adding and subtracting stages of compression to a compressor in order to increase and decrease the pumping capacity as and when required to satisfy a given load requirement.

### FIELD OF THE INVENTION

The present invention relates to multi-stage compressors. More specifically, the present invention is concerned with multi-stage compressors of variable pumping capacity and pressure ratios.

### BACKGROUND OF THE INVENTION

Compressors used in most industries are often required to vary both their pumping capacity and their pressure ratios. In the particular instance of the air conditioning and refrigeration industries, cooling or heating loads vary throughout the year for example, and the required pressure ratios vary accordingly as the condensing temperatures and evaporating temperatures vary. Typically, as the outside ambient temperature rises, so do the required pressure ratio and the required capacity. Moreover, the higher the pressure ratio, the less flexible the compressor becomes in its ability to unload, resulting in a smaller operating window and in more energy being required to pump the gas.

Traditionally, centrifugal compressors are designed to be efficient in achieving a specific “flow” and “head” at a predetermined “design point”. When conditions change, a compressor must then operate at “off design” in a very wide range of conditions, resulting generally in worse energy efficiency. The efficiency, capacity, lift and range of a compressor can be improved in off design conditions by introducing means to vary the flow. In some industrial processes, compressors may have to supply air or other types of gas at different volumes and different pressures, depending on a relevant demand at the time.

Although typically more efficient than other forms of compressors, centrifugal compressors are also less flexible in simultaneously handling high-pressure ratios and low capacity demand. Centrifugal compressors can supply high-pressure ratios by adding more stages of compression in series with one another. While this method of pumping can allow high-pressure ratios, it also limits the ability for the compressors to unload without going into a condition known as surge.

As known in the art, when designing a centrifugal compressor, it is much easier to design a single stage compressor than a two-stage compressor, and it is much easier to develop a two-stage compressor than a three-stage compressor, especially when all stages are mounted on a same rotating shaft and operate at a same rotational speed, and it is much easier to develop a three-stage compressor than a four-stage compressor, etc.

Another difficulty in designing a multi-stage compressor is to design it so that it may handle high pressure ratios while having a required turndown minimum capability.

There is therefore still a need in the art for a multi-stage compressor.

### SUMMARY OF THE INVENTION

More specifically, there is provided a multi-stage compressor, comprising a rotating shaft, a primary pumping circuit comprising at least one primary stage, the at least one primary stage being coupled to the rotating shaft; and a secondary pumping circuit comprising at least one secondary stage, wherein each one of the at least one secondary stage is adapted to be coupled and un-coupled from the rotating shaft.

There is further provided a method for adjusting the capacity of a multi-stage compressor comprising a rotating shaft and a primary pumping circuit comprising at least one primary stage coupled to the rotating shaft, comprising determining current capacity requirements of the multi-stage compressor; coupling at least one secondary stage to the rotating shaft to increase the capacity, and decoupling at least one of the at least one secondary stage from the rotating shaft to decrease the capacity, as determined by the previous step.

There is further provided a coupling assembling for coupling a secondary stage to a rotating shaft of a compressor comprising a primary stage, comprising a permanent magnet inserted into either one of the end of the rotating shaft or the secondary impeller and a magnetic piece inserted into the remaining one of the secondary impeller or the end of the rotating shaft, the secondary stage being held onto the rotating shaft by magnetic forces between the permanent magnet and the magnetic piece.

There is further provided a coupling assembly for coupling a secondary impeller to a rotating shaft of a compressor comprising a primary stage, comprising a first magnet inserted in the rotating shaft; and a second magnet inserted in the secondary impeller, the secondary impeller attaching itself to the rotating shaft by the attraction strength between opposing poles of the first and second magnets.

There is further provided an assembly for coupling and decoupling a secondary impeller to a rotating shaft of a compressor comprising a primary stage, comprising a magnet inserted in the rotating shaft; and an electromagnet supported by the secondary impeller, wherein when the electromagnet is on, a force between the electromagnet and the magnet drives the secondary impeller away from the rotating shaft, and when the electromagnet is off the secondary impeller is attracted to the magnet embedded in the rotating shaft and the secondary impeller couples to the rotating shaft.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 show a compressor with a primary pumping circuit comprising two primary stages and a secondary pumping circuit comprising two secondary stages, with the two secondary stages uncoupled (FIG. 1A); with only one of the two secondary stages uncoupled (FIG. 1B); and with both secondary stages coupled (FIG. 1C), according to an embodiment of an aspect of the invention;

FIG. 2 shows a compressor with two primary stages and a single secondary stage, all in a coupled state, according to an embodiment of an aspect of the invention;

FIG. 3 show a compressor with two secondary stages mounted on the secondary pumping circuit, in a direction opposite to that of the primary stages of the primary pumping circuit, in a coupled state (FIG. 3A), and in an uncoupled state (FIG. 3B), according to an embodiment of an aspect of the invention;

FIG. 4 show a compressor with one of two primary stages and one of two secondary stages mounted on each side of the rotating shaft, the secondary stages being decoupled (FIG. 4A), and coupled (FIG. 4B) respectively, according to an embodiment of an aspect of the invention;

FIG. 5 shows a compressor with two primary stages and one of two secondary stages mounted on each side of the rotating shaft, only one of the secondary stages being decoupled, according to an embodiment of an aspect of the invention;

FIG. 6 illustrate various configurations and ways for decoupling and re-coupling a secondary or subsequent additional stages to a compressor: 6A) coupled; 6B) decoupled, 6C) decoupled, 6D) decoupled; 6E) coupled; 6F) decoupled using an electromagnetic device; 6G) coupled using a secondary rotor; 6H) decoupled using an electromagnetic device and a secondary rotor, according to embodiments of an aspect of the invention;

FIG. 7 show a method of bypassing the gas through the secondary impeller, according to an embodiment of an aspect of the present invention;

FIG. 8 shows an example of curves of the pressure ratio as a function of capacity in relation to the number of stages in a compressor;

FIG. 9 illustrate a way for decoupling (FIG. 9B) and re-coupling (FIG. 9A) a secondary stage to a compressor, according to a further embodiment of the invention;

FIG. 10 illustrate a system incorporating bypass port and decoupling assembly into a single device, according to a further embodiment of the invention;

FIG. 11 shows another method for coupling and uncoupling a secondary impeller to a rotating shaft; and

FIG. 12 illustrates a compressor, according to an embodiment of an aspect of the present invention.

### DESCRIPTION OF ILLUSTRATIVE EMBODIMENTS

The present invention is illustrated in further details by the following non-limiting examples.

There is generally provided a system and a method for adding and subtracting stages of compression to a compressor as, and when, the compressor requires them.

For example, if the compressor needs only a low pressure ratio, then the system and method allow the compressor to operate with only a primary pumping circuit spinning, while available additional stages, forming a secondary pumping circuit, and which may be required at other times when the required pressure ratios increase, being decoupled from the rotating shaft, so that the compressor only pumps at its most efficient and flexible point.

On the contrary, when a higher pressure ratio is required, such as when outside ambient temperatures increase in the middle of summer in an air-conditioning installation for example, since the additional stages are required in order to reach higher pressure ratios, the system and method allow to re-couple them to the rotating shaft, thereby allowing these additional stages to spin with the rotating shaft, thereby allowing the compressor to reach the required higher pressure ratios.

According to the present invention, each one of the primary pumping circuit and the secondary pumping circuit of the compressor may include one or more stages. If the secondary pumping circuit comprises more than one stage, then these stages may be decoupled or re-coupled to the rotating shaft, either successively or at the same time, as will be further discussed.

It may be desirable that the secondary stages be positioned with their suction inlet facing in the direction along the rotating shaft axis, since, as the impellers have a natural tendency to drive themselves towards the direction of the incoming gas, this may add to the frictional force of the coupling's two mating surfaces and reduce the likelihood of any possible slippage between the impeller and the rotating shaft. It is important that all impellers spin at the same RPM (revolutions per minute), as, if the secondary impeller happens to slip and turn at a slower speed, this may lead to compressor inefficiencies and wear between the mating surfaces of the rotating shaft and the secondary impeller.

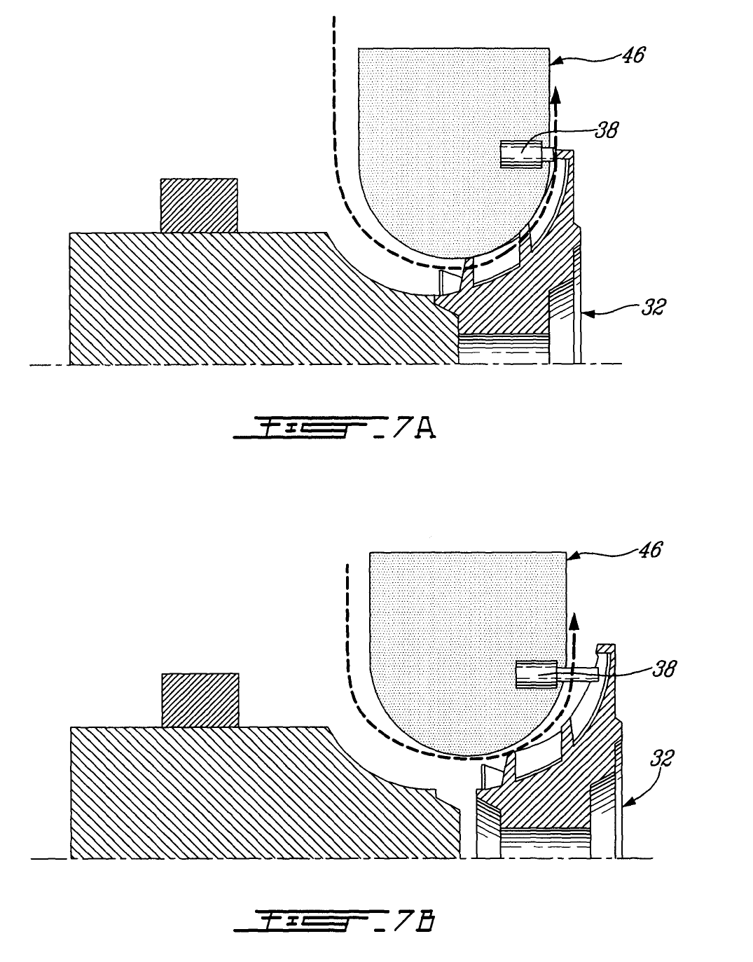

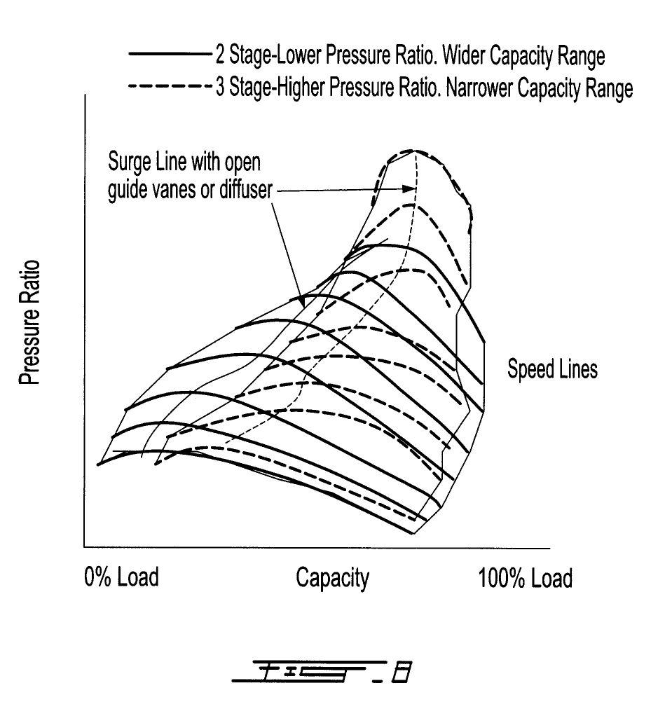

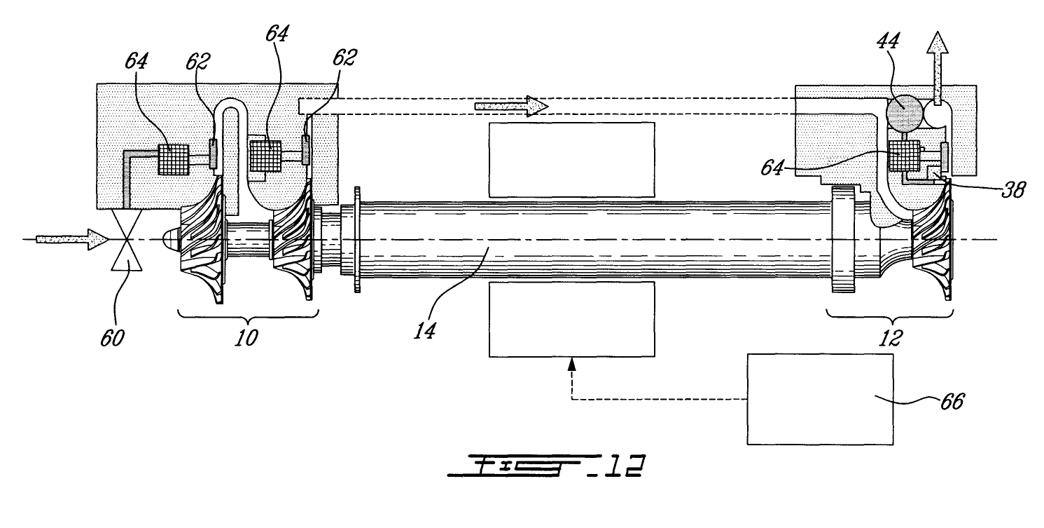

Moreover, by incorporating variable frequency drives, inlet guide vanes, and/or variable diffusers, the compressor loading and unloading capability may further be increased. Indeed, in compressors, such as those described in U.S. Pat. No. 5,857,348 for example, the unloading mechanism and pressure ratio control is primarily handled by varying the speed of the compressor: in conditions where the compressor is likely to experience a surge condition, then inlet guide vanes, or exit wall diffusers, start to close off, thereby allowing the compressor to reduce its pumping capacity to a greater extent than it could have had these devices not been activated (see FIG. 12). Surging occurs when the static pressure in the discharge volute overcomes the dynamic pressure of the gas leaving the impeller and the gas flows backwards in the diffuser to the impeller and the compressor stops pumping. The compressor efficiently operates within specific boundaries as determined by the compressor's operating map, and once the gas flow reduces beyond that point, the compressor surges. FIG. 8 shows that the compressor's ability to operate at low load decreases as the number of stages thereof is increased.

A single or multiple bypass port may be provided into the discharge gas stream of the secondary pumping circuit, to allow the gas stream to bypass the non-rotating secondary impeller(s) and thus reduce unnecessary loads onto the non-rotating secondary impeller(s) and increase the overall compressor efficiency by thus eliminating associated frictional losses.

As an alternative to bypass ports, the outer sealing surface of the impeller, referred to as the shroud, may be moved away from the impeller by a distance where the frictional losses become insignificant, in which case no bypass is required. As known to people in the art, the distance between the impeller and the shroud is a most important clearance parameter in a centrifugal compressor and should be kept as tight as possible, since, the tighter the distance, the more efficient the compressor's performance.

In cases when the shroud 46 is brazed to the impeller or otherwise becomes part of the impeller, the gas seal may be provided by some other means, such as a labyrinth seal, as known in the art.

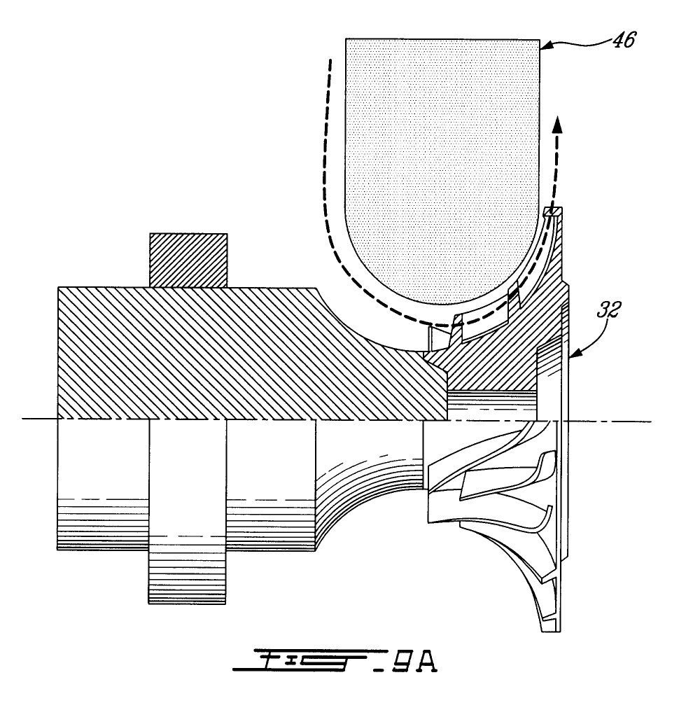

In the case of an open shrouded design as shown in FIG. 9 for example, where the shroud 46 remains stationary and the impeller 32 turns, then it may be possible to actually either move the impeller 32 far enough away from the shroud 46, or to move the shroud 46 far enough away from the impeller 32, or move them both apart, so that the gas can flow freely around the impeller 32 and frictional losses become irrelevant to the compressor's performance (see FIG. 9B). Then, there is no need for a separate bypass port.

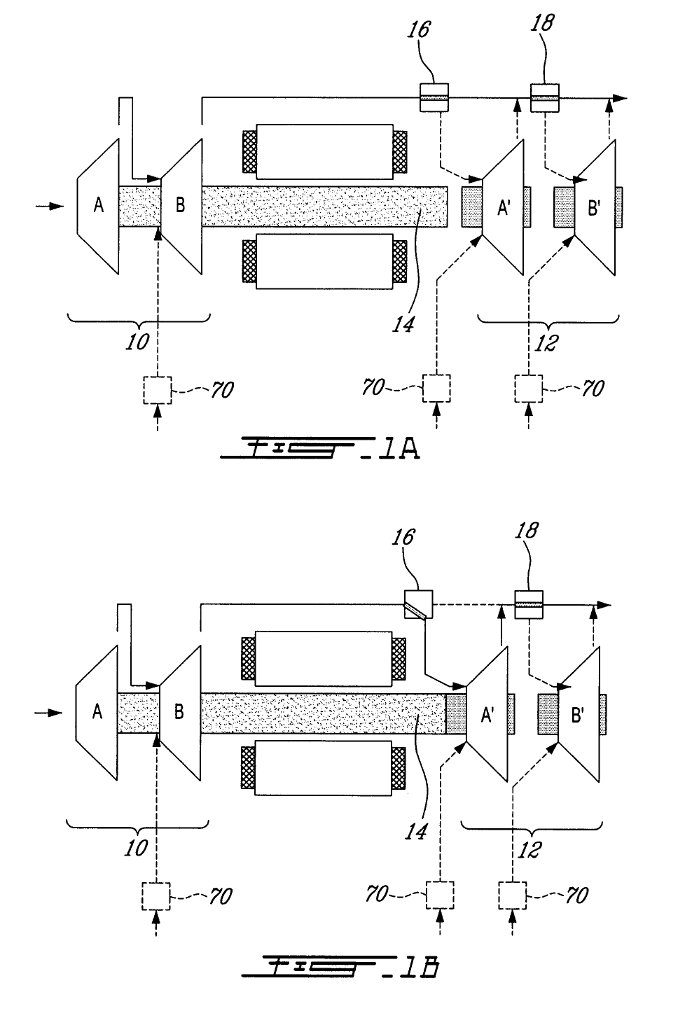

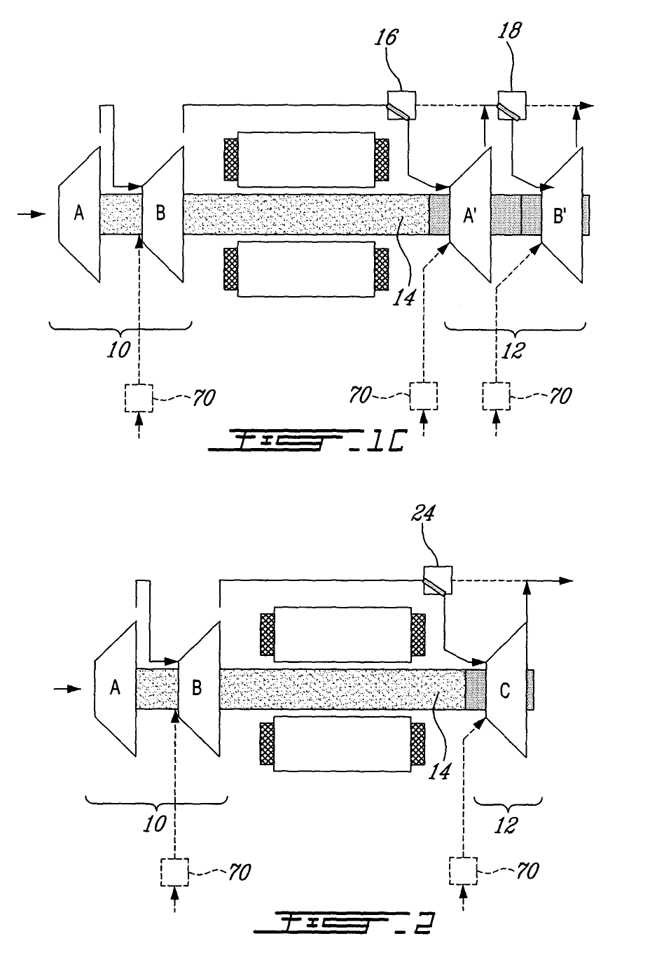

FIG. 1 show a compressor with a primary pumping circuit 10 comprising two primary stages A and B and a secondary pumping circuit 12 comprising two secondary stages A′ and B′.

In FIG. 1A, the secondary stages A′ and B′ are decoupled from the rotating shaft 14 of the compressor, respective bypass valves 16 and 18 diverting the gas flow away from each one of the secondary stages A′ and B′.

In FIG. 1B, a first one A′ of the two secondary stages is re-coupled to the rotating shaft 14, the first bypass port 16 diverting the gas flow through this first secondary stages A′, whereas a second one B′ of the two secondary stages is still uncoupled and the second bypass port 18 still diverts the gas flow from going through this second one B′ of the two secondary stages of the secondary pumping circuit 12.

In FIG. 1C, both secondary stages A′ and B′ are re-coupled and their respective bypass ports 16 and 18 closed so that the gas flows through them both and the compressor becomes fully activated.

The examples shown in FIG. 1 are not meant to limit the number of stages that may be incorporated into either the primary 10 or the secondary 12 pumping circuit, from at least one per impeller per primary circuit 10 and per secondary circuit 12.

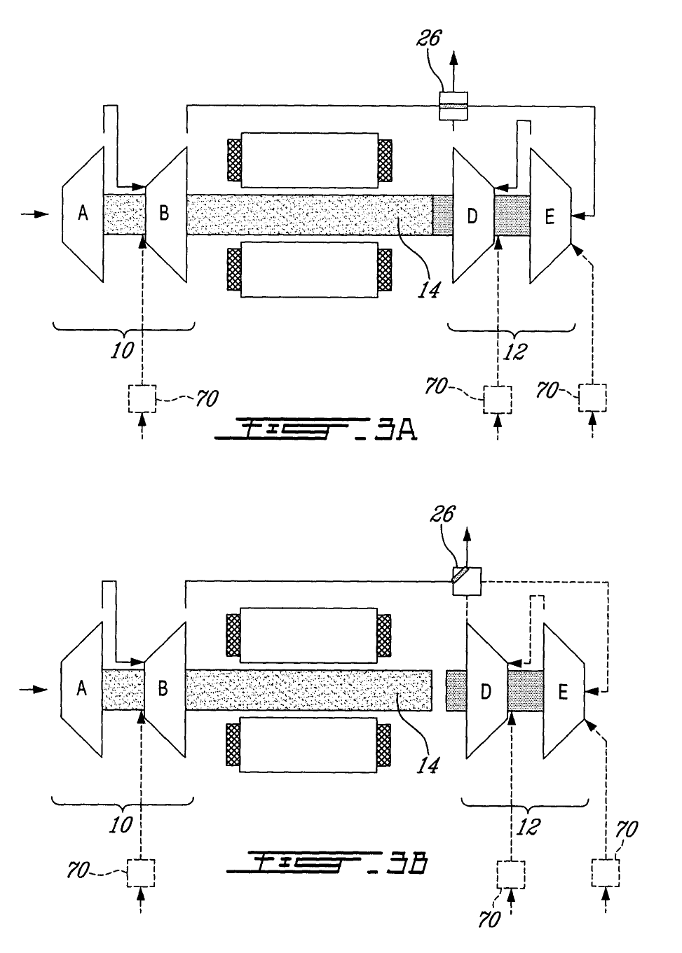

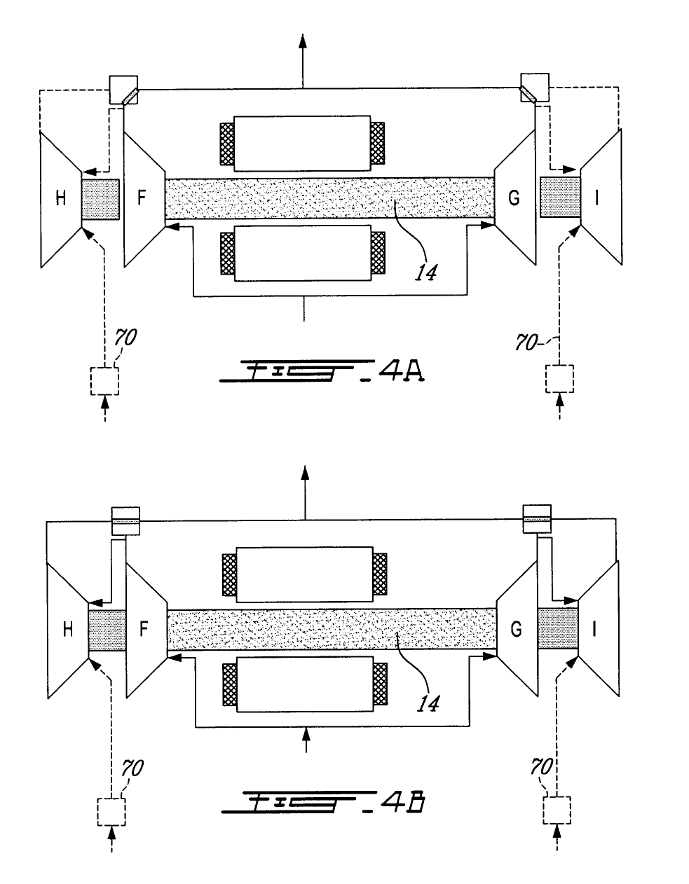

For example, FIG. 2 shows a compressor with two primary stages A and B and a single secondary stage C with a bypass port 24.

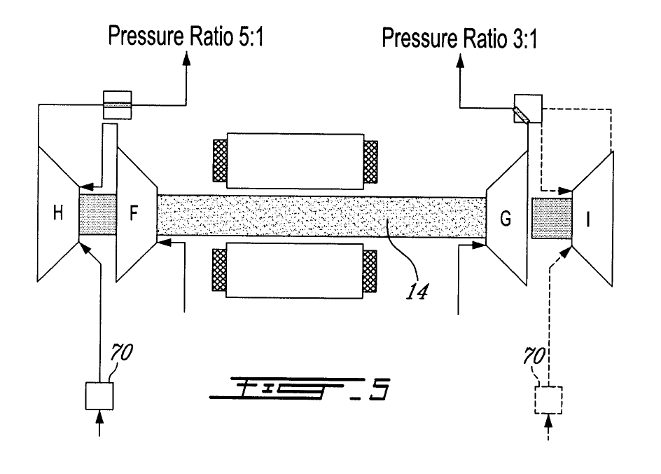

In FIG. 3, two secondary impellers D and E are mounted on the secondary pumping circuit 12, in a direction opposite to that of the primary impellers A and B of the primary pumping circuit 10. In this particular case, both secondary impellers are decoupled (see FIG. 3B) or re-coupled (see FIG. 3A), simultaneously, using a single bypass port 26.

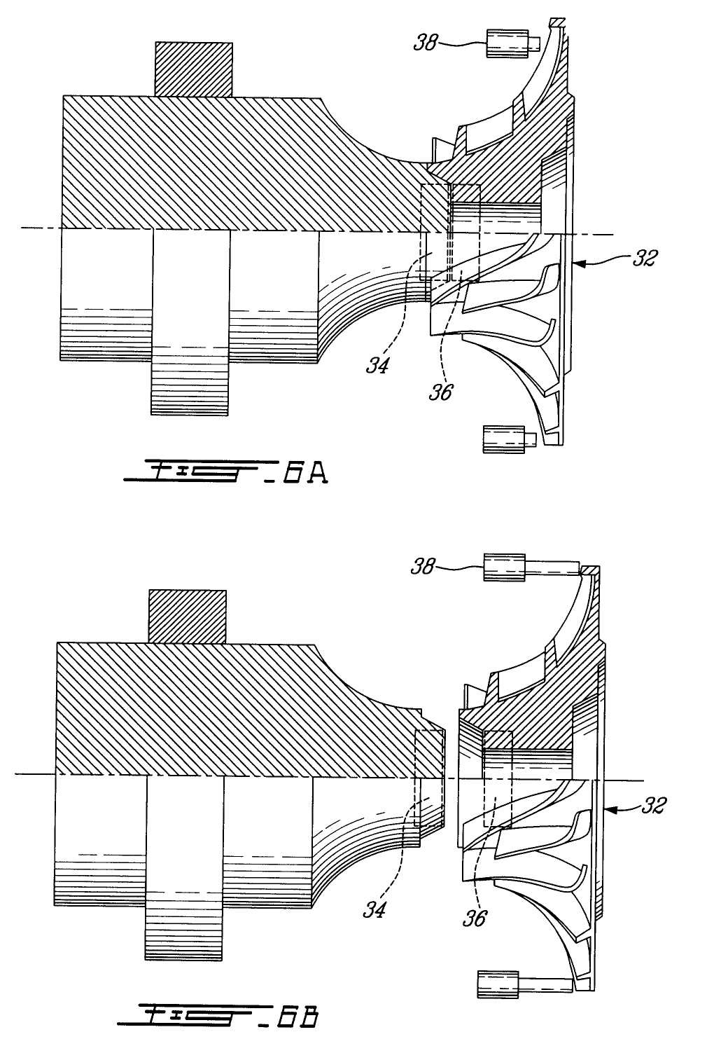

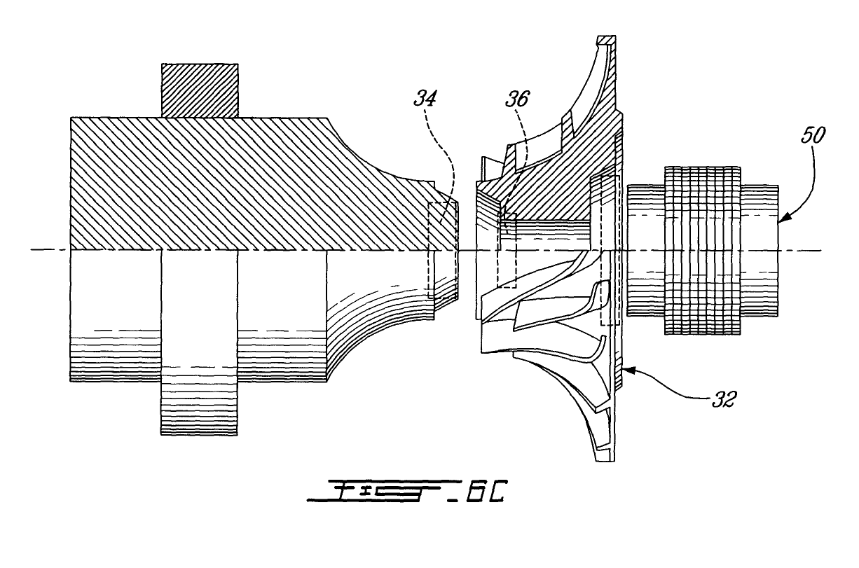

In FIG. 4, one of two primary pumps F, G is mounted on each side of the rotating shaft 14 to balance the thrust forces, secondary impellers H and I being decoupled (FIG. 4A) or coupled (FIG. 4B) on each end of the rotating shaft 14 respectively.

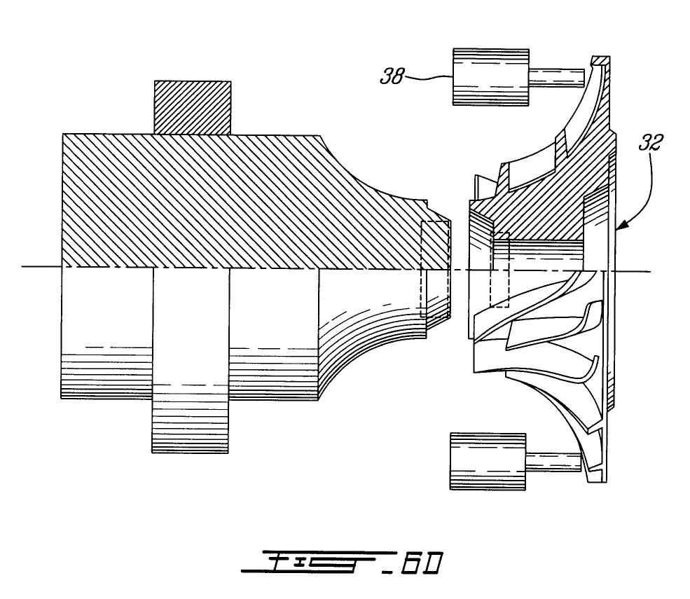

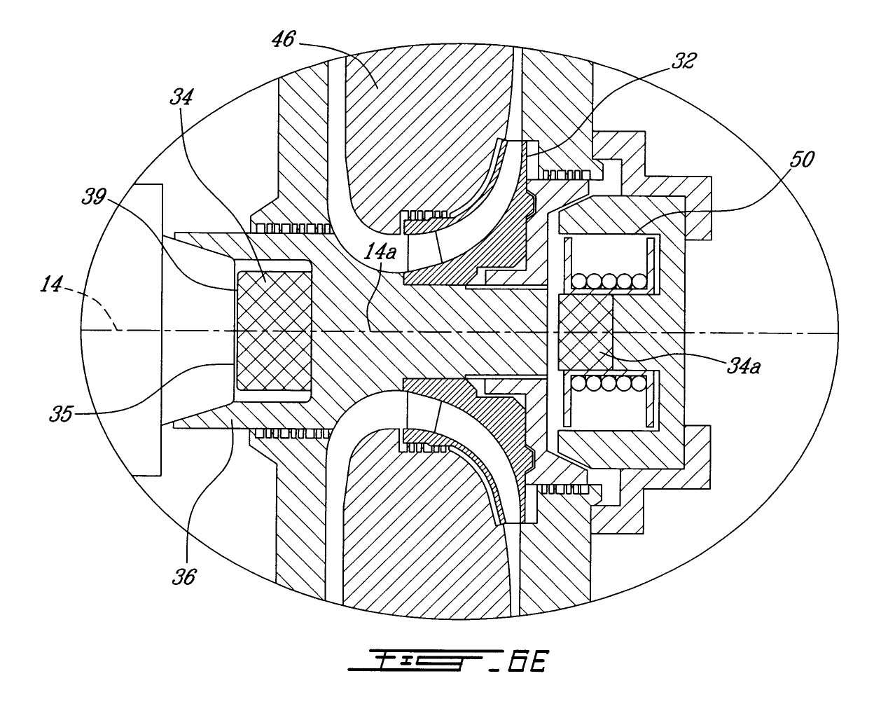

The secondary impellers H and I may be decoupled or re-coupled simultaneously or not, depending on whether the required pressure ratios are the same at each end of the rotating shaft 14, and this of course depends on whether the discharge gas is being pumped into the same circuit or not. For example, in FIG. 5, the secondary impeller H is coupled while the secondary impeller I is decoupled due to different required pressure ratios.

An interstage port 70 may be provided between two consecutive stages, as shown in FIGS. 1 to 5, allowing addition of refrigerant between each stage, depending on the application. As people in the art will appreciate, the interstage port can be utilized as an economizer port to further subcool the liquid refrigerant which may result in an increase of compressor efficiency.

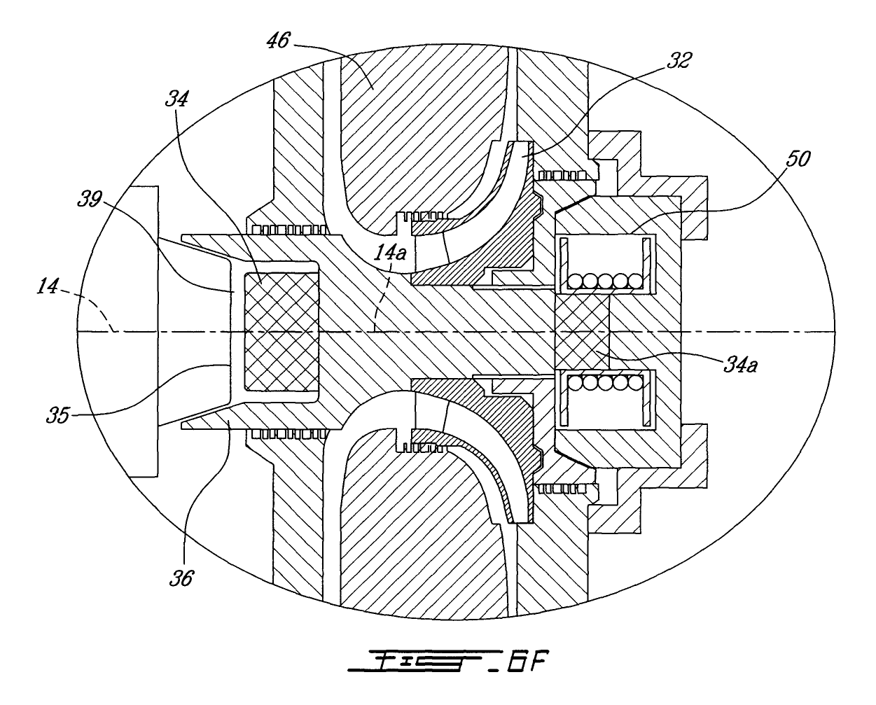

The coupling and uncoupling to and from the rotating shaft 14 of the compressor may be done in several ways, by using mechanical, magnetic or electromechanical or electromagnetic means. For the purpose of this description, the secondary stages are held onto the rotating shaft 14 by means of magnetic forces in FIG. 6.

In FIGS. 6A and 6B, as a way of example, a secondary stage 32 is held onto the rotating shaft 14 by means of a magnetic force between a permanent magnet 34 inserted into either one of the end of rotating shaft 14 (FIGS. 6A, 6B for example) or the secondary impeller 32 and a magnetic iron piece 36 inserted into the remaining one of the secondary impeller 32 or the end of the rotating shaft 14. A decoupling assembly 38 allows separating the end of the rotating shaft 14 and the secondary impeller when needed.

Alternatively, a first magnet could be inserted in the rotating shaft 14 and a second magnet could be inserted in the secondary impeller 32, the secondary impeller 32 attaching itself to the rotating shaft 14 by means of the attraction strength between the opposing poles of the two magnets.

In FIG. 6C, an electromagnet 50 having a force greater than the magnet 34 in the rotating shaft 14 is used for attracting the secondary impeller 32 away from the rotating shaft 14. When the electromagnet 50 is off the secondary impeller 32 is attracted to the magnet 34 embedded in the rotating shaft 14 and the secondary impeller 32 re-couples thereto.

In FIG. 6D, a decoupling assembly 38 is shown as a mechanical device that pushes the secondary impeller 32 away from the rotating shaft 14 in an axial direction, so as to create a physical gap between the two mating surfaces. The magnetic force between the rotating shaft 14 and the secondary impeller 32 is unchanged, ensuring that the secondary impeller 32 remains in its axial correct position. The mechanical device 38 could be one or more levers, arms, pins, gears, rings or such device that is driven by mechanical, hydraulic, electric motor, linear motion motor or electromechanical or magnetic or electromagnetic field or device.

In FIG. 6E, the secondary impeller 32 is coupled to the rotating shaft 14 by way of a permanent magnet 34a embedded in the shaft 14a of the secondary impeller 32 and the electromagnetic device 50 being de-energized.

In FIG. 6F, the electromagnet 50 having a force capacity greater than that of a magnet 34 in the shaft 14a is used for attracting the secondary impeller 32 away from the rotating shaft 14, as, when the electromagnet 50 is energized, the secondary impeller 32 is attracted to a permanent magnet 34a embedded in the holder of the electromagnet 50, whereby the secondary impeller 32 is retained in a decoupled position requiring no additional power to remain stationary, hence creating a further energy saving means.

In FIG. 6G, two back-to-back secondary impellers 32 are coupled to the rotating shaft 14a on a first side, by way of a permanent magnet 34 embedded in a rotating shaft 14b and the electromagnetic device 50 being de-energized.

In FIG. 6H, an electromagnet 50 having a greater force capacity than the magnet 34 in the shaft 14b is used for attracting the back-to-back secondary impellers 32 away from the rotating shaft 14a. When the electromagnet 50 is energized, then the back-to-back secondary impellers 32 are attracted to the permanent magnet 34a embedded in the electromagnetic holder and the back-to-back secondary impellers 32 are retained in a decoupled position requiring no additional power to remain stationary, hence creating a further energy saving means.

It is possible to use one or two secondary shrouded impellers 32 on its secondary rotating shaft in such a way as to be able to incorporate significantly more impeller mass and axial overhang whilst reducing the rotational frictional losses by means of utilizing additional mechanical or passive or active magnetic bearings 55 or a combination thereof (see FIGS. 6G, 6H).

It may also be possible to manufacture either the rotating shaft or the secondary impeller out of a magnetic material, such as a magnetic metal, and have the permanent magnet incorporated into the remaining part of one of the shaft or the secondary impeller.

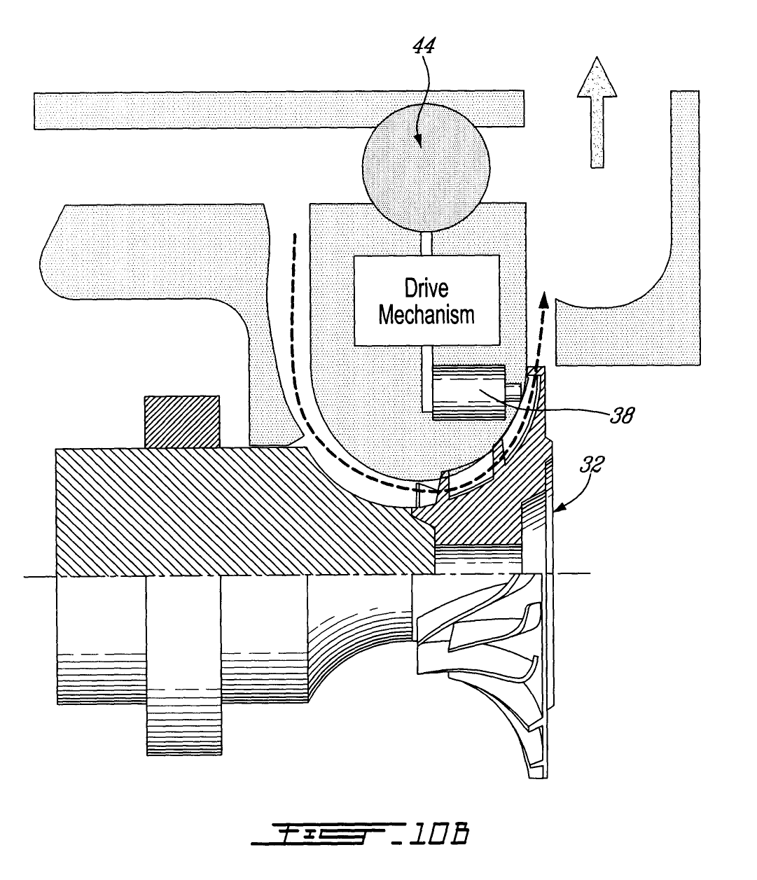

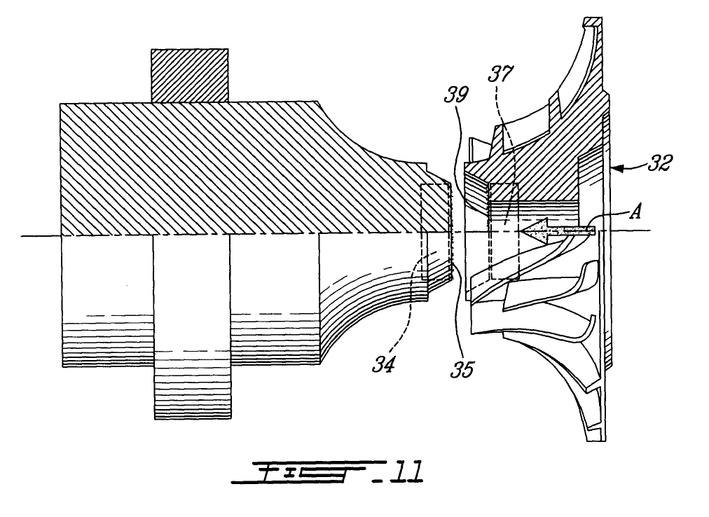

Coupling sprocket or gear or clutch or rough surface or some other way such as additional magnets may be further provided to eliminate the risk of slippage between the rotating shaft 14 and the secondary impeller 32, which may occur under high load conditions. In FIG. 11, the rotating shaft 14 is provided with a permanent magnet 34, while the hub 37 of the secondary impeller 32 is made in low carbon, magnetically soft steel, and the mating surfaces 35, 39 have a rough surface or some other form of assembly that prevents the secondary impeller 32 from slipping on the rotating shaft 14 as it rotates and transmits torque from the rotor, through the coupling to the impeller 32. The arrow (A) indicates the direction of force from the magnet and the impeller's natural thrust.

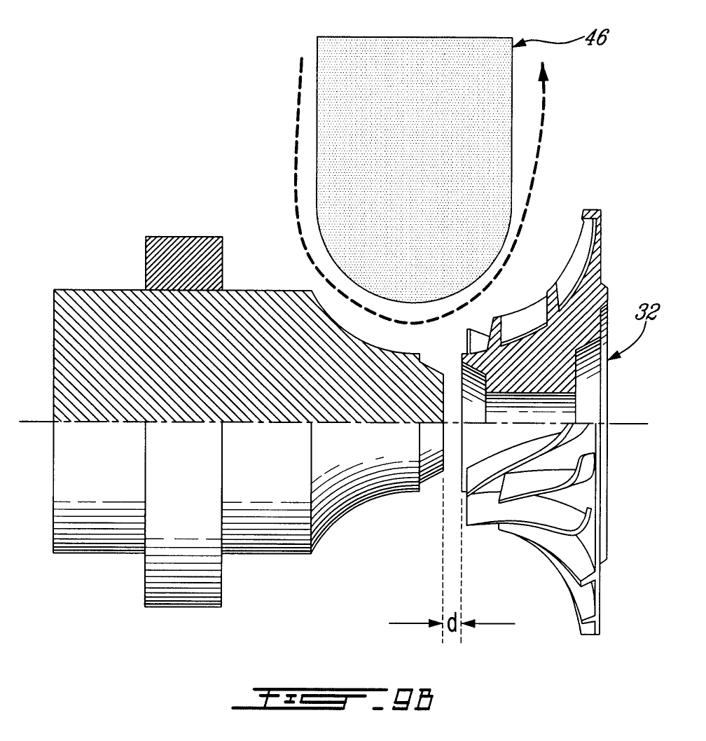

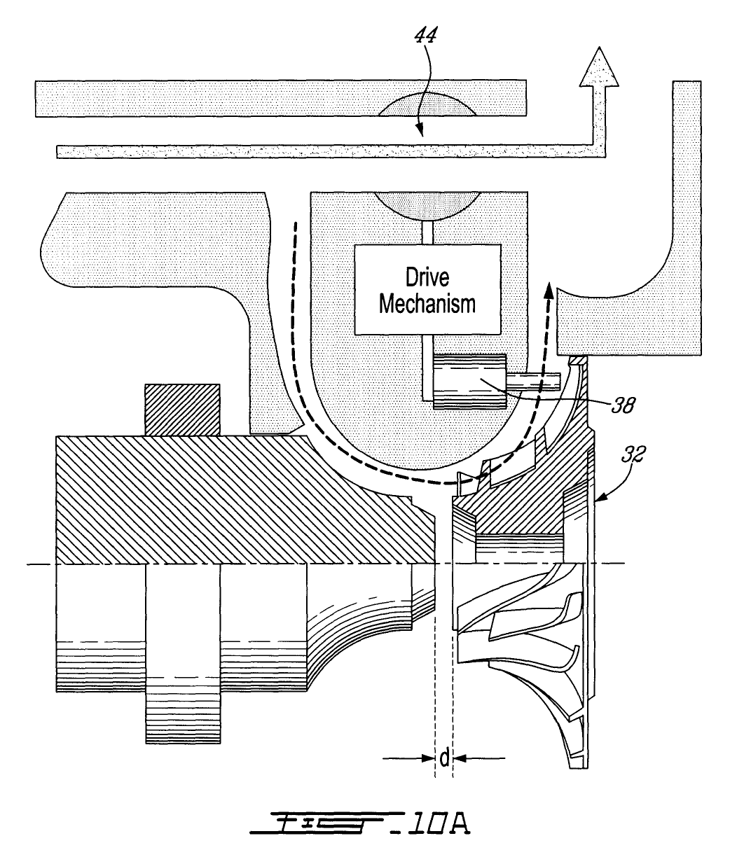

In order to simplify the design of the bypass port and the decoupling assembly, it may be desirable to mechanically or electrically link the two devices together or to incorporate them into a single device, as shown in FIG. 10 for example.

FIG. 10A shows the secondary impeller 32 moved axially away from the rotating shaft 14 and the bypass port 44 open so that the gas bypasses the impeller 32. While the distance separating the impeller 32 from the rotating shaft 14 is exaggerated for illustration purposes, in practice the impeller 32 only needs to move away from the rotating shaft 14 by a distance d as little as 0.02″ in order for it to clear the shaft 14. FIG. 10B shows the impeller 32 in its operating position with the bypass port 44 closed.

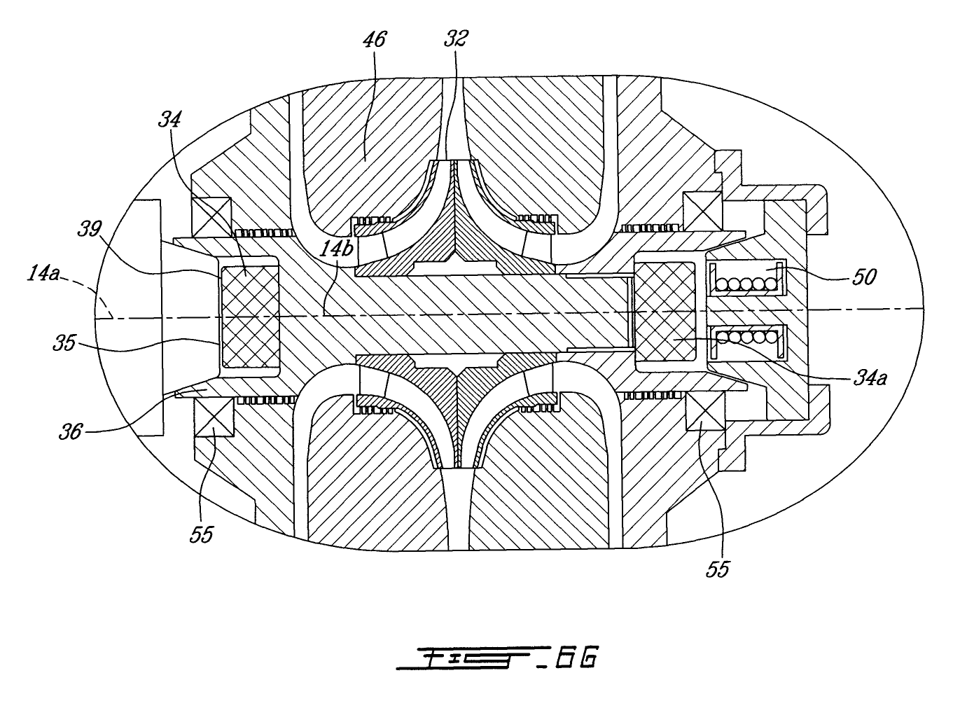

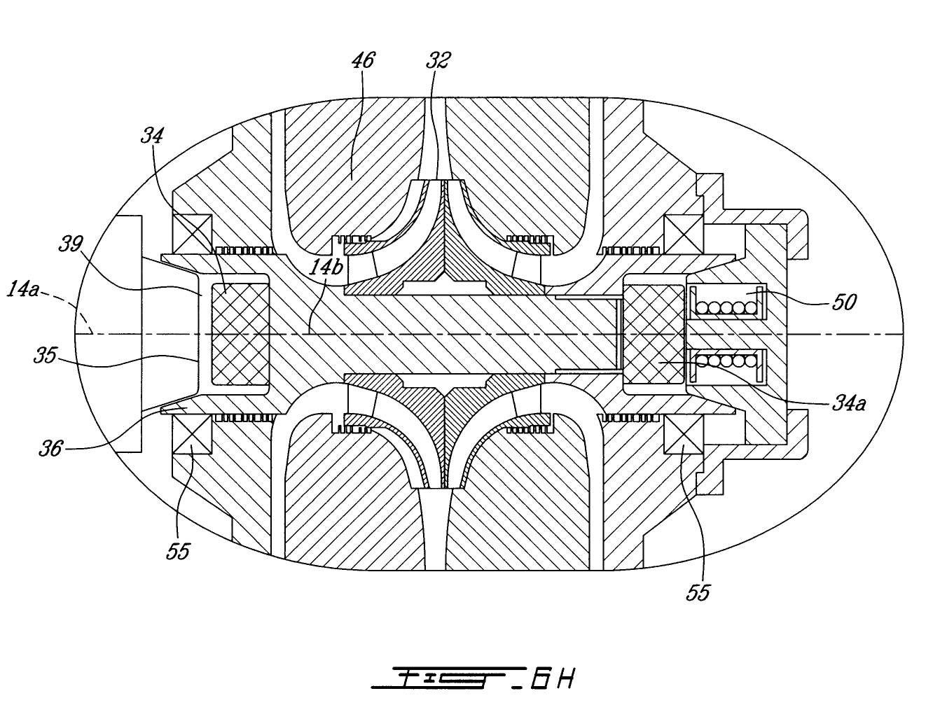

FIG. 7 show another method of bypassing the gas through the secondary stage without affecting the compressor's efficiency, by moving the secondary impeller 32 far enough away from the rotating shaft 14, by mechanical magnetic or electromagnetic means 38 so that the frictional losses through the gas passages become insignificant. As mentioned hereinabove, although the secondary impeller 32 only has to clear the rotating shaft 14 by a few thousandths of an inch to become decoupled, if the gas flow from the primary impellers continues through the stationary decoupled secondary impeller 32, then the secondary impeller 32 tends to try and spin as the gas blows through the blades. Even if clamping the secondary impeller 32 from turning, the pressure losses through the secondary impeller 32 may then be significant enough to cause unacceptable inefficiencies on the entire compressor. However, if the wall of the shroud 46 is moved away far enough from the tips of the blades, then the pressure drop through this passage reduces, and even reduces to an acceptable level. There may be a cost advantage of moving the wall of the shroud 46 over adding a bypass port, for a similar net effect as a bypass port.

The compressor shown in FIG. 12 incorporates variable frequency drives 66, variable walled diffuser and/or variable geometry blade diffuser 62 and/or variable inlet guide vanes 60, to increase its unloading capability.

There are many ways that a decision may be made to determine if secondary stages should be decoupled or re-coupled to the rotating shaft of a compressor, as described hereinabove. Once this decision is made, the compressor shuts down, or at least slows down to a point where the additional stages can be decoupled or re-coupled to the rotating shaft without putting the impellers at risk of damaging themselves.

One such way of determining whether a secondary pumping circuit should be coupled or decoupled may comprise, for example, determining the ambient temperature. For example, the compressor may be made to shut down once the ambient temperature reaches a threshold temperature, such as 104° Fahrenheit (40° Celsius) for instance, for re-coupling secondary impeller(s) to the rotating shaft, before the compressor is restarted with the additional stage(s) assembled to the primary stage(s) previously operating alone. In contrast, when the ambient temperature drops to a threshold temperature such as 95° Fahrenheit (35° Celsius) for instance, the compressor may be made to shut or slow down for decoupling the secondary impeller(s) from the rotating shaft, before the compressor is restarted, the secondary impeller(s) being this time inactivated. The control and system logic not being specifically disclosed herein but being known to those in the particular field of application.

The present method of operating a compressor not only allows the compressor to achieve required high pressure ratios, but also allows additional stages of a secondary circuit to be left out when they are no longer required, which in turn allows the compressor to unload its pumping capacity much lower than it could, had the additional stages not been decoupled. The net result of this is a more efficient and flexible designed compressor. Additionally, with the increasing demand for products offering better energy efficiency, the compressor herein can be better optimized to provide improved load matching, capacity control and efficiency at multiple design points.

The invention described here enhances the compressor's ability to operate in wide ranging conditions with improved efficiency by way of allowing the skilled designer to select a configuration to achieve and optimize multiple specific design points within the same compressor by way of selecting how many impellers are required to meet the specific capacity and head requirement. Moreover, it provides a feed back loop and control system logic used to optimize the compressor's performance and determine when to switch to multiple compressor stages.

Although the present invention has been described hereinabove by way of specific embodiments thereof, it can be modified, without departing from the nature and teachings of the subject invention as defined in the appended claims.

1. A multi-stage compressor, comprising: a rotating shaft; a primary pumping circuit comprising at least one primary stage, said at least one primary stage being coupled to said rotating shaft; and a secondary pumping circuit comprising at least one secondary stage; wherein each one of said at least one secondary stage is adapted to be coupled and un-coupled from said rotating shaft.

2. The multi-stage compressor of claim 1, further comprising at least one bypass valve able to divert gas flow from said at least one secondary stage when said at least one secondary stage is un-coupled from said rotating shaft.

3. The multi-stage compressor of claim 1, wherein said primary pumping circuit comprises a first primary stage and a second primary stage; said secondary pumping circuit comprises a first secondary stage and a second secondary stage; said multi-stage compressor comprising a first bypass valve connecting said primary pumping circuit and said first secondary stage and a second bypass valve connecting said primary pumping circuit and said second secondary stage.

4. The multi-stage compressor of claim 1, wherein said primary pumping circuit comprises a first primary stage and a second primary stage, said secondary pumping circuit comprises a single secondary stage with a bypass port.

5. The multi-stage compressor of claim 1, wherein said at least one secondary stage is mounted on said secondary pumping circuit in a direction opposite to that of the at least one primary stage of the primary pumping circuit.

6. The multi-stage compressor of claim 1, comprising one bypass valve connected to each one of said at least one secondary stage of said secondary pumping circuit.

7. The multi-stage compressor of claim 1, wherein said primary pumping circuit comprises a first primary stage mounted on a first end of said rotating shaft and a second primary stage mounted on a second end of said rotating shaft; said secondary pumping circuit comprises a first secondary stage and a second secondary stage; said first secondary stage being adapted to be coupled and decoupled from said rotating shaft at said first end of said rotating shaft, and said second secondary stage being adapted to be coupled and decoupled from said rotating shaft at said second end of said rotating shaft.

8. The multi-stage compressor of claim 1, wherein said primary pumping circuit comprises a first primary stage mounted on a first end of said rotating shaft and a second primary stage mounted on a second end of said rotating shaft; said secondary pumping circuit comprises a first secondary stage and a second secondary stage; said first secondary stage being adapted to be coupled and decoupled from said rotating shaft at said first end of said rotating shaft, and said second secondary stages being adapted to be coupled and decoupled from said rotating shaft at said second end of said rotating shaft, said first and second secondary stage being adapted to be coupled and decoupled simultaneously and at different times, depending on whether required pressure ratios are the same at each end of the rotating shaft.

9. The multi-stage compressor of claim 1, comprising an interstage port between two consecutive stages.

10. The multi-stage compressor of claim 1, further comprising at least one of: i) mechanical means, ii) magnetic means and iii) electromagnetic means to couple and un-couple said at least one secondary stage from said rotating shaft.

11. The multi-stage-compressor of claim 1, comprising: a permanent magnet inserted into a first one of: i) an end of said
rotating shaft and ii) the at least one secondary stage and a magnetic iron piece inserted into a second one of: i) said end of said rotating shaft and ii) the at least one secondary stage, said at least one secondary stage being held onto the rotating shaft by means of a magnetic force between said permanent magnet and said magnetic iron piece; and a decoupling assembly allowing separating the rotating shaft and the at least one secondary stage when needed.

12. The multi-stage compressor of claim 1, comprising a first magnet inserted in the rotating shaft and a second magnet inserted in said at least one secondary stage, said at least one secondary stage attaching itself to the rotating shaft by means of the attraction strength between said first and second magnets.

13. The multi-stage compressor of claim 1, comprising a magnet embedded in the rotating shaft, and an electromagnet supported by said at least one secondary stage, said electromagnet attracting said at least one secondary stage away from the rotating shaft when said electromagnet is on, whereas when the electromagnet is off, said at least one secondary stage is attracted to said magnet embedded in the rotating shaft for coupling thereto.

14. The multi-stage compressor of claim 1, comprising a mechanical device that pushes the at least one secondary stage away from said rotating shaft in an axial direction.

15. The multi-stage compressor of claim 12, wherein said mechanical device is selected between at least one of: levers, arms, pins, gears and rings.

16. The multi-stage compressor of claim 12, wherein said mechanical device is driven by one of: mechanical, hydraulic, electric motor, linear motion motor and magnetic field.

17. The multi-stage compressor of claim 1, further comprising one of: i) coupling sprocket, ii) gear and iii) rough surface to prevent slippage between the rotating shaft and said at least one secondary stage.

18. The multi-stage compressor of claim 1, further comprising at least one bypass valve able to divert gas flow from said at least one secondary stage when said at least one secondary stage is un-coupled from said rotating shaft, wherein the at least one bypass valve is mechanically or electrically linked to a decoupling assembly.

19. A method for adjusting the capacity of a multi-stage compressor comprising a rotating shaft and a primary pumping circuit comprising at least one primary stage coupled to said rotating shaft, comprising: determining current capacity requirements of the multi-stage compressor; coupling at least one secondary stage to said rotating shaft to increase the capacity, and decoupling at least one of said at least one secondary stage from said rotating shaft to decrease the capacity, as determined by said previous step.

20. The method of claim 19, wherein the multi-stage compressor is at least slowed down for coupling and for decoupling the at least one secondary stage.

21. A coupling assembly for coupling a secondary stage to a rotating shaft of a compressor comprising a primary stage, comprising a permanent magnet inserted into either one of the end of the rotating shaft or the secondary impeller and a magnetic piece inserted into the remaining one of the secondary impeller or the end of the rotating shaft, said secondary stage being held onto the rotating shaft by magnetic forces between said permanent magnet and said magnetic piece.

22. A coupling assembly for coupling a secondary impeller to a rotating
shaft of a compressor comprising a primary stage, comprising: a first magnet inserted in the rotating shaft; and a second magnet inserted in the secondary impeller, the secondary impeller attaching itself to the rotating shaft by the attraction strength between opposing poles of said first and second magnets.

23. A coupling assembly of claim 22, further comprising a device that pushes the secondary impeller away from the rotating shaft in an axial direction, to separate mating surfaces between the end of the rotating shaft and the secondary impeller thereby decoupling the secondary impeller from the compressor, and a bypass port able to be opened when the secondary impeller is uncoupled from the rotating shaft, so that gas bypass the secondary impeller.

24. A coupling assembly of claim 22, further comprising a mechanical device that pushes the secondary impeller clear away from the rotating shaft in an axial direction, said mechanical device being one or more levers, arms, pins, gears or rings, and a bypass port able to be opened when the secondary impeller is uncoupled from the rotating shaft, so that gas bypasses the secondary impeller.

25. A coupling assembly of claim 22, further comprising a mechanical device that pushes the secondary impeller clear away from the rotating shaft in an axial direction, said mechanical device being driven by mechanical, hydraulic, electric motor, linear motion motor or electromechanical or magnetic or electromagnetic field.

26. An assembly for coupling and decoupling a secondary impeller to a rotating shaft of a compressor comprising a primary stage, comprising: a magnet inserted in the rotating shaft; and an electromagnet supported by said secondary impeller; wherein when the electromagnet is on, a force between the electromagnet and the magnet drives the secondary impeller away from the rotating shaft, and when the electromagnet is off the secondary impeller is attracted to the magnet embedded in the rotating shaft and the secondary impeller couples to the rotating shaft.
